(19) United States
(12) Patent Application Publication
(10) Pub. No.: US 2004/0128577 A1
(43) Pub. Date: Jul. 1, 2004

(54) Add-in module providing always-on connectivity for mobile personal computer

(76) Inventor: Kelan C. Silvester, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/330,805

(22) Filed: Dec. 27, 2002

(51) Int. Cl. G06F 1/32

(52) U.S. Cl. 713/324

(57) ABSTRACT

Apparatus and methods are provided to allow for the provision of always-on connectivity to a mobile PC using an add-in module. In one embodiment, the present invention includes receiving a wireless signal bearing data at an add-in module connected to a mobile personal computer (PC) that is turned off. The data can then be extracted from the received signal, and stored in a memory of the add-in module while the mobile PC is turned off. In one embodiment, the present invention can further include detecting that the mobile PC has been turned on, and sending the data stored in the memory of the add-in module to the mobile PC.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field

Embodiments of the present invention relate generally to the field of mobile data communications. More particularly, embodiments of the present invention relate to an add-in module that provides some communications capabilities to a mobile personal computer even when the mobile personal computer is turned off, and to a mobile personal computer to receive such an add-in module.

2. Description of the Related Art

Mobile personal computers (PCs), such as laptop computers, continue to increase in popularity. Wireless networks that provide for mobile communications connectivity to these mobile PCs are therefore also increasing. Many airports and other public places already have wireless networks, such as Wi-Fi, that can connect mobile PCs to the Internet.

When in transit, and not connected to a power outlet, mobile PCs are powered by batteries that need to be periodically recharged. Without recharging, the batteries used by current mobile PCs can generally provide 2-4 hours of “on” time. Thus, when in transit, mobile PCs are generally turned off to conserve power, as well as for other reasons. When turned off, they cannot receive data from wireless networks.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating an exemplary mobile personal computer architecture in which various embodiments of the present invention may be employed.

FIG. 2 is a block diagram illustrating an exemplary mobile personal computer connected to an add-in module according to one embodiment of the present invention.

FIG. 3 is a block diagram illustrating an exemplary add-in module according to one embodiment of the present invention.

FIG. 4 is a flow diagram illustrating data processing according to one embodiment of the present invention.

FIG. 5 is a flow diagram illustrating data processing according to another embodiment of the present invention.

### DETAILED DESCRIPTION

Mobile Personal Computer

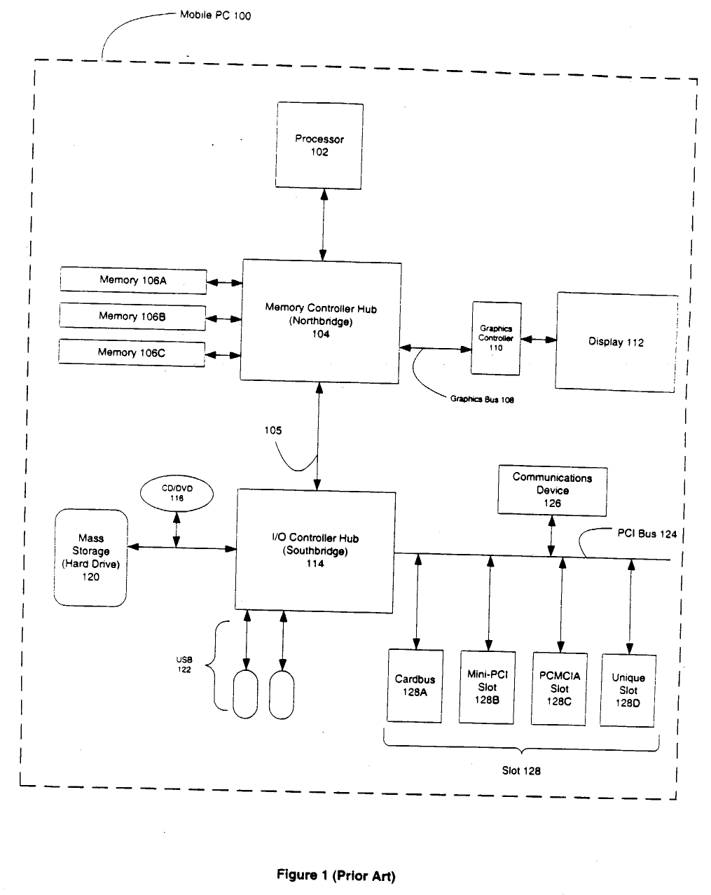

An example mobile PC that can be enhanced using embodiments of the present invention is now described with reference to FIG. 1. The mobile PC 100 illustrated in FIG. 1 is only one possible architecture of a mobile PC that can be enhanced using embodiments of the present invention. Many other mobile PC platforms are equally suitable.

The mobile PC 100 can have a memory controller hub 104 connecting the memory 106(A-C), the display 112, and the processor 102. In some mobile PCs architectures, the memory controller hub 104 is sometimes referred to as the Northbridge because it provides a bridge between the host processor 102 and the rest of the computer system. The processor can be a high-performance notebook central processing unit (CPU) commonly used in mobile PCs. The memory system 106(A-C) can include any storage medium used by mobile PCs. For example, memory 106A can be a static random access memory (SRAM), memory 106B can be a dynamic random access memory (DRAM), and memory 106C can be a read only memory (ROM). The display 112 can be a liquid crystal display (LCD) display or other suitable display technology. The display 112 can be connected to the memory controller hub 104 by a high-speed graphics bus 108 and graphics controller 110, such as an Accelerated Graphics Port (AGP) bus.

In one embodiment, the input/output (I/O) controller hub 114, also known in some architectures as the Southbridge, is connected to the memory controller hub 104 by a point-to-point connection 105. In other architectures, a shared bus may link them. The I/O controller hub 114 controls the operation of the mass storage 120, such as a hard drive, the CD/DVD drive 116, the Universal Serial Buses (USBs) 122, and the Peripheral Component Interconnect (PCI) bus 124. The PCI bus 124 can be used to connect a communications device 126, such as a modem or wireless receiver, to the mobile PC 100. Furthermore, the PCI bus 124 can provide various slots 128 that allow add-in modules to be connected to the mobile PC 100. For example, a slot 128 can include a Cardbus 128A, a Mini-PCI Slot 128B, a Personal Computer Memory Card International Association (PCMCIA) Slot 128C designed to receive PC-Cards, or any unique or proprietary slot 128D either now in existence or developed in the future.

Example Scenario

The following scenario illustrates one benefit of the present invention. If a user of the mobile PC 100 described above plans to take a business trip, he may want to respond to his outstanding emails on the airplane. If he turns his mobile PC 100 off, then travels to the airport and boards his airplane, when he turns the mobile PC 100 on, he has not been connected to the Internet since he left his office. Thus, his emails may not be up to date, because emails received after he left the office could not have been downloaded to his mobile PC 100. This is true even if the airport he walked through was equipped with a wireless data network, since he did not turn the mobile PC 100 on, perhaps to conserve power or because he was in a hurry.

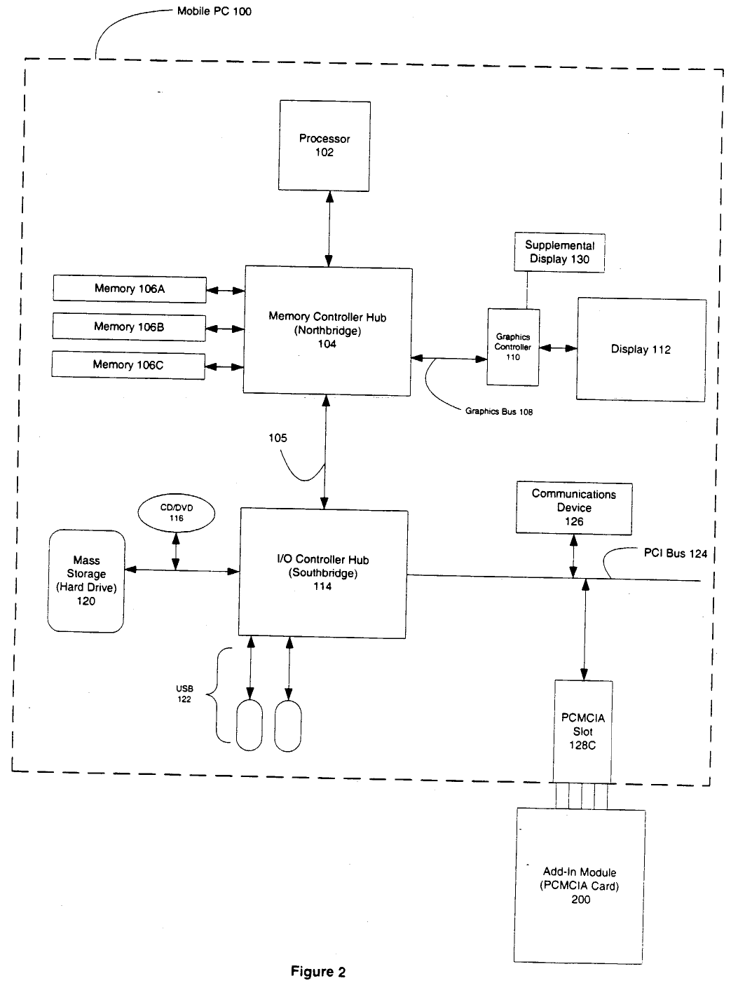

However, if his mobile PC 100 were connected to an add-in module providing always-on connectivity according to an embodiment of the present invention, his email would have been updated as he walked through the airport, even though the mobile PC 100 was turned off. The term “always-on” means that the mobile PC is able to establish communications connections even when it is turned off, so long as it is in the range of an accessible wireless network. Such always-on connectivity can be useful in various other situations. FIG. 2 illustrates an add-in module 200 connected to the mobile PC 100 to provide the always-on connectivity. In the example of FIG. 2, the add-in module 200 is a PCMCIA Card, also known as a PC-Card, that plugs into the PCMCIA Slot 128C of the mobile PC 100.

The Add-In Module

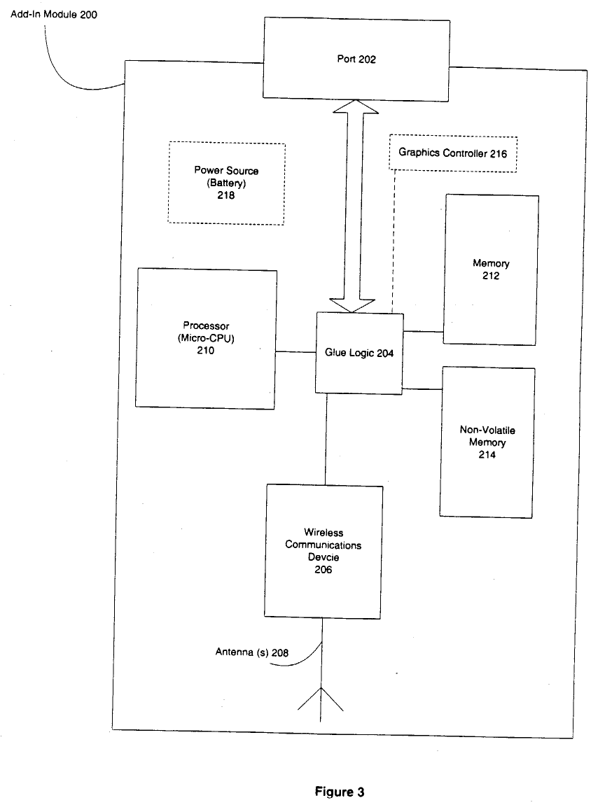

Several embodiments of the add-in module 200 of the present invention are described with reference to FIG. 3. In one embodiment, the components of the add-in module 200 are communicatively connected by a glue logic 204. The add-in module 200 can include an antenna 208 or antennas, such as an antenna array, and a wireless communications device 206. These elements provide wireless communications capabilities to the add-in module 200. The wireless communications device 206 may include a digital signal processor, but the processor 210 can also perform any necessary signal processing.

The processor 210 can be a micro-controller, such as a Micro-CPU, an embedded processor or other capable DSP. The processor 210 can perform the signal and data processing needed to carry out the operations of the add-in module discussed further below. The operating system and software code for the processor 210 can be stored in non-volatile memory 214. The non-volatile memory can be a FLASH memory, a ROM, or other battery-backed or otherwise non-volatile memory.

When wireless signals, such as radio signals from a wireless local area network (WLAN), are received by the wireless communications device 206, and processed by processor 210, the received data can be stored in a memory 212. The memory 212 can be a RAM or other fast memory. During operation, the operating system and software code stored in the non-volatile memory 214 can be transferred to the memory 212 for quicker access. Similarly, the data stored in the memory 212 can be periodically backed up, or transferred to the non-volatile memory 214 for safer storage.

The add-in module 200 connects to the mobile PC 100 using a port 202. In addition to providing a connection to the mobile PC 100, the port can also provide access to the power supply, such as the battery, of the mobile PC 100. In this case, the mobile PC 100 can provide power to the add-in module 200. In another embodiment, the add-in module 200 can have its own power source 218, such as a battery, located on the add-in module 200. If the add-in module 200 includes a power source 218, then this power source may recharge itself using the power supply of the mobile PC 200. In one embodiment, the add-in module can also include a graphics controller 216 to operate a supplemental display located either on the add-in module, or on the mobile PC.

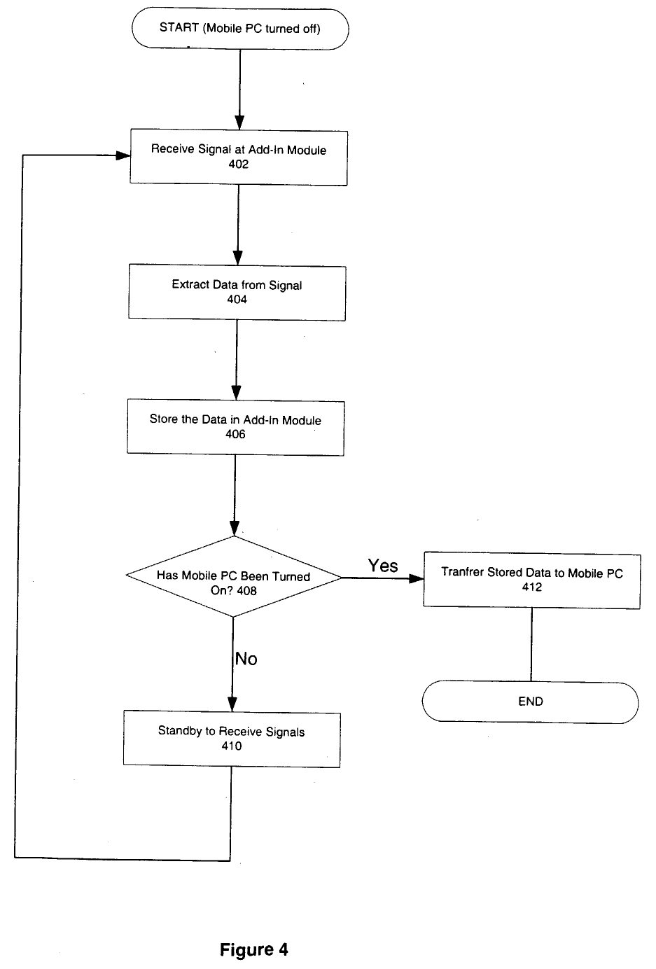

One embodiment of the operation of the add-in module 200 is now described with reference to FIG. 4. The method described in FIG. 4 starts when the mobile PC 100 is turned off. The add-in module 200 can be used for wireless communication even when the mobile PC 100 is turned on, but the “always-on” features become active when the mobile PC 100 is turned off. Being “off” can mean any number of low-energy states where the host processor 102, memory controller hub 104, memory system 106, and other major components of the mobile PC are not active.

In one embodiment, the mobile PC 100 being turned off means that the mobile PC 100 is in an S3, S4, or S5 power state, as defined in the Advanced Control and Power Interface (ACPI) Specification. As defined by the ACPI specification, in the S3 state, power is removed from the host processor 102. In he S4 state, power is removed from all systems, but only after saving the system state to the mass storage 120 for later refresh. The S4 state is sometimes referred to as hibernation. In the S5 state, all power is removed from the system. Generally, when laypeople say a computer is off, they mean it is in state S5. However, in this embodiment, the mobile PC 100 being off can mean the mobile PC 100 being in any of the above low-power states.

After the mobile PC 100 is turned off, a wireless signal can be received 402 at the add-in module 200. This can be done using the antenna(s) 208 and the wireless communications device 206. The wireless signal can come from a wireless LAN accessible to the add-in module 200. The received signal can be an incoming email or other server initiated communication, such as an update of the users computerized calendar indicating a meeting scheduled after be left the office. Furthermore, the signal can be a response for an update request, for example, for a stock quote. In this manner, the add-in module can “pull” data from a server even when the mobile PC 100 is turned off using the always-on functionality provided by the add-in module 200.

Then, the data in the received signal can be extracted 404. This can be done by a specialized DSP or by the processor 210 that controls the add-in module 200. The received data can then be stored 406 on the add-in module 200 while the mobile PC 100 remains turned off. Thus, if the mobile PC 100 has not been turned on 408, then the add-in module 200 stands by to receive 410 further signals.

If, however, the mobile PC 100 does get turned on 408, then the data is transferred 412 from the add-in module 200 to the mobile PC 100. The transfer can be arranged using any appropriate protocol. For example, the processor 210 of the add-in module 200 can send the data stored in the memory 212 to the memory 106 of the mobile PC 100 directly upon detecting that the mobile PC 100 has been turned on. Alternately, the mobile PC 100 can alert the add-in module 200 that it has been turned on and request the stored data. Many such message exchanges between the mobile PC 100 and the add-in module 200 can be used to arrange for the transfer, such as the transmission control protocol/internet protocol (TCP/IP) network data exchange or some other standard or unique exchange.

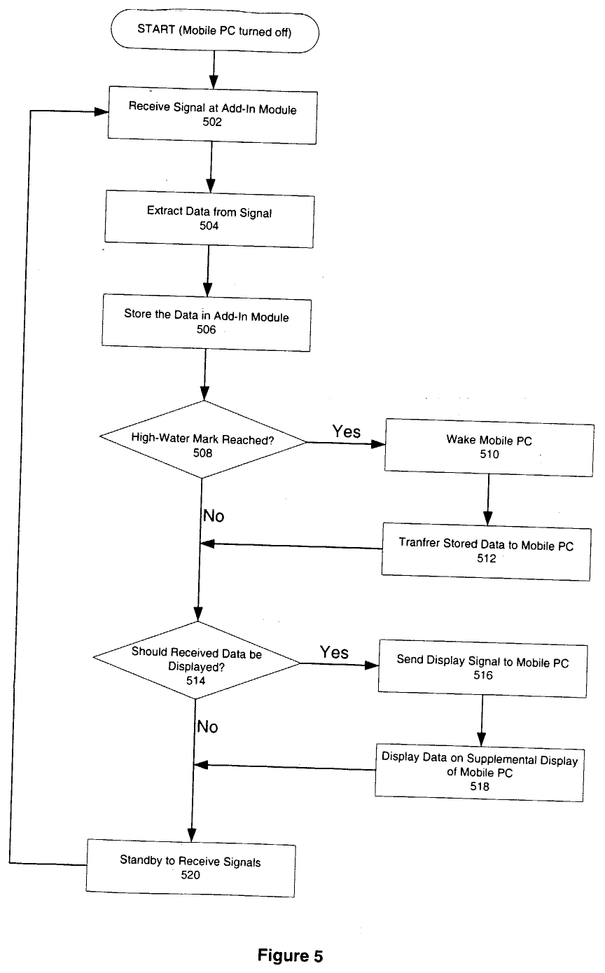

Another embodiment of the operation of the add-in module 200 is now described with reference to FIG. 5. The method described in FIG. 5 also starts when the mobile PC 100 is turned off, and continues to receiving 502 a wireless signal, extracting 504 the data from the signal, and storing 506 the data in the memory 212 of the add-in module 200, in the manner described with reference to FIG. 4. Then, a decision is made 508 as to whether the amount of data stored in the memory 212 of the add-in module 200 has reached a capacity threshold level or high-water mark.

If the high-water mark has been reached, then there is some danger of loosing future data, and memory should be made available on the add-in module. In one embodiment, this is done by waking 510 the mobile PC 100 and transferring the stored data, or at least a portion of the stored data, to the memory 106 or the mass storage 120 of the mobile PC 100. Waking the mobile PC 100 can be done using a standard “wake on LAN” implementation, or other waking mechanism.

Waking the mobile PC need not include completely turning the mobile PC 100 on. Waking can include only powering up the components needed to transfer the data from the add-in module 200 to the mobile PC 100. For example, the graphics controller 110 and the display 112 need not be woken up to accomplish this.

If the high-water mark has not been reached, no immediate data transfer is necessary. In other embodiments, the decision to wake up the mobile PC 100 is not based on the amount of data in the memory 212 of the add-in module 200. For example, if a wake command, such as a “magic packet” is received at the add-in module 200 from a server, similar wake operations can be initiated.

Then, a determination is made whether the received data includes data that should be displayed 514. If there is information to display, then the add-in module 200 can generate and send 516 a display signal to the mobile PC 100. An add-in module 200 of this embodiment can include a graphics controller 216 to generate such a signal. Since the signal is ready for display, the mobile PC 100 can display 518 the information contained in the display signal without being turned on.

The display signal can be displayed using a supplemental display 130 of the mobile PC 100. The supplemental display 130 may use less power than main display 112 and may be easier to wake. Furthermore, the supplemental display 130 may be positioned so that it is visible even when the mobile PC 100 is in a closed position. If there is no data to display, then the add-in module stands by 520 to receive further wireless signals.

General Matters

In the description above, for the purposes of explanation, numerous specific details have been set forth. However, it is understood that embodiments of the invention may be practiced without these specific details. In other instances, well-known circuits, structures and techniques have not been shown in detail in order not to obscure the understanding of this description.

Embodiments of the present invention include various processes. The processes may be performed by hardware components or may be embodied in machine-executable instructions, which may be used to cause one or more processors programmed with the instructions to perform the processes. Alternatively, the processes may be performed by a combination of hardware and software.

Embodiments of the present invention refer to the add-in module receiving signals from a Wi-Fi wireless network. However, the add-in module could be communicating with any wireless network, including radio, cellular, GPRS, Bluetooth, wireless LAN, infrared, or any other wireless technology.

Embodiments of the present invention refer to a mobile PC. The term mobile PC is not limited to any manufacturer or chipmaker, and includes laptop and various other mobile computers, such as notebook computers, Apple laptop computers, and other such computing devices.

Embodiments of the present invention have been sometimes described to as enabling a mobile PC to receive data when turned off. However, other embodiment of the present invention can include sending data when the mobile PC is turned off.

Embodiments of the present invention have been described with reference to an add-in module. The add-in module has sometimes been described as a PC-card. However, the add-in module can also be provided as a proprietary card, a Mini-PCI card, or any present or future add-in module technology.

Embodiments of the present invention may be provided as a computer program product that may include a machine-readable medium having stored thereon instructions, which may be used to program a computer (or other electronic device) to perform a process according to one or more embodiments of the present invention. The machine-readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a wireless signal bearing data at an add-in module connected to a mobile personal computer (PC) that is turned off;
extracting the data from the received signal; and
storing the extracted data in a memory of the add-in module while the mobile PC is turned off.

2. The method of claim 1, further comprising:
detecting that the mobile PC has been turned on; and
sending the data stored in the memory of the add-in module to the mobile PC.

3. The method of claim 1, further comprising:
generating a display signal using at least part of the data; and
sending the display signal to the mobile PC to be displayed on a supplemental display.

4. The method of claim 1, further comprising:
sending a wake signal to the mobile PC to turn the mobile PC on; and
sending the data stored in the memory of the add-in module to the mobile PC.

5. The method of claim 4, wherein sending the wake signal is in response to the memory of the add-in module storing a threshold amount of data.

6. The method of claim 4, wherein sending the wake signal is in response to the received wireless signal containing a wake command.

7. The method of claim 1, wherein receiving the wireless signal, extracting the data, and storing the data are performed by the add-in module.

8. The method of claim 7, wherein the add-in module comprises a PCMCIA card, and the PCMCIA card is connected to the mobile PC using a PCMCIA slot.

9. An add-in module to plug into a mobile personal computer (PC), the add-in module comprising:
a port to establish a connection to the mobile PC;
a wireless communications device to receive wireless signals bearing data;
a processor, coupled to the wireless communications device, to extract the data from the wireless signals;
a memory, coupled to the processor, to store the extracted data when the mobile PC is turned off.

10. The add-in module of claim 9, further comprising a non-volatile memory, coupled to the processor, to store an operating system used by the add-in module.

11. The add-in module of claim 10, wherein the non-volatile memory comprises a FLASH memory.

12. The add-in module of claim 9, wherein the wireless communications device comprises an antenna and a receiver.

13. The add-in module of claim 9, further comprising a battery to supply power to the add-in module.

14. The add-in module of claim 13, wherein the battery is coupled to the port, and the battery recharges by accessing a notebook power-source using the port.

15. The add-in module of claim 9, wherein the port further supplies electricity to the add-in module when connected to the mobile PC by accessing a notebook battery.

16. The add-in module of claim 9, further comprising a graphics controller, coupled to the processor and the port, to drive a supplementary display on the mobile PC.

17. The add-in module of claim 9, wherein the processor stores the extracted data in memory when the processor determines that the mobile PC is turned off.

18. The add-in module of claim 17, wherein when the processor determines that the mobile PC is turned on, the processor sends the data stored in the memory to the mobile PC using the port.

19. The add-in module of claim 9, wherein the processor is further to, when the data stored in the memory reaches a threshold amount, turn the mobile PC on by sending a wake signal to the mobile PC using the port.

20. The add-in module of claim 9, wherein the processor is further to, when the received wireless signal contains a wake command, turn the mobile PC on by sending a wake signal to the mobile PC using the port.

21. The add-in module of claim 9, wherein the add-in module comprises a PCMCIA card, and the port comprises a PCMCIA port to be received by a PCMCIA slot.

22. An add-in module to plug into a mobile personal computer (PC), the add-in module comprising:
connection means for connecting to the mobile PC;
reception means for receiving wireless signals bearing data;
processing means for processing the received signals to extract the data;
storage means for storing the extracted data when the mobile PC is turned off; and
power means for supplying power to the add-in module.

23. The add-in module of claim 22, further comprising means for waking the mobile PC using the connection means.

24. The add-in module of claim 22, wherein the connection means comprises a PCMCIA port.

25. The add-in module of claim 22, wherein the storage means comprises a memory located on the add-in module.

26. The add-in module of claim 22, wherein the storage means comprises means for accessing a memory located in the mobile PC using the connection means.

27. The add-in module of claim 22, wherein the power means comprises a battery located on the add-in module.

28. The add-in module of claim 22, wherein the power means comprises means for accessing a battery located in the mobile PC using the connections means.

29. A machine-readable medium having stored thereon data representing instructions which, when executed by a processor of an add-in module, cause the processor to perform operations comprising:
receiving a wireless signal bearing data at an add-in module connected to a mobile personal computer (PC) that is turned off;
extracting the data from the received signal; and
storing the extracted data in a memory of the add-in module while the mobile PC is turned off.

30. The machine-readable medium of claim 29, wherein the instructions further cause the processor to perform operations comprising:
detecting that the mobile PC has been turned on; and
sending the data stored in the memory of the add-in module to the mobile PC.

31. The machine-readable medium of claim 29, wherein the instructions further cause the processor to perform operations comprising:
generating a display signal using at least part of the data; and
sending the display signal to the mobile PC to be displayed on a supplemental display.

32. The machine-readable medium of claim 29, wherein the instructions further cause the processor to perform operations comprising:
sending a wake signal to the mobile PC to turn the mobile PC on; and
sending the data stored in the memory of the add-in module to the mobile PC.

33. The machine-readable medium of claim 32, wherein sending the wake signal is in response to the memory of the add-in module storing a threshold amount of data.

34. The machine-readable medium of claim 32, wherein sending the wake signal is in response to the received wireless signal containing a wake command.

35. A mobile personal computer (PC) comprising:
a slot to receive an add-in module, the add-in module able to receive and store data when the mobile PC is turned off;
a processor, coupled to the slot, to request the data stored on the add-in module when the computer is turned on;
and a memory to store the requested data.

36. The mobile PC of claim 35, further comprising a supplementary display, coupled to the slot, to display data received from the slot when the mobile PC is turned off.

37. The mobile PC of claim 35, wherein the slot comprises a PCMCIA slot and the add-in module comprises a PCMCIA card.

38. The mobile PC of claim 35, further comprising a battery, coupled to the slot, to supply power to the add-in module.
